(19) United States
(12) Patent Application Publication
(10) Pub. No.: US 2008/0307702 A1
(43) Pub. Date: Dec. 18, 2008

(54) Method and Device for Treating Trees

(75) Inventors: Cordula Heidecke, Tharandt (DE); Diana Rodekohr, Solingen (DE); Jurgen Holters, Leverkusen (DE); Andreas Roloff, Tharandt (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 10/581,114

(22) PCT Filed: Nov. 18, 2004
(86) PCT No.: PCT/EP04/13099

§ 371 Date: Aug. 25, 2008

(30) Foreign Application Priority Data
Dec. 1, 2003 (DE) 103 56 040.8

(51) Int. Cl. A01G 7/06

(52) U.S. Cl. 47/57.5

(57) ABSTRACT

There are described a devices for the treatment of woody plants, comprising a cylindrical injection element (1) with an axial bore (2); a radial slot (3) which communicates with the bore (2) and whose longitudinal axis runs essentially parallel to the axial bore (2); a fixing element (4) and an element for connecting a reservoir (5), and a variety of embodiments of this device;
apparatuses comprising these devices, and
method of using this device in the treatment of woody plants.

The present invention relates to devices for treating woody plants, an apparatus comprising this device, and methods of treating woody plants.

The treatment of woody plants with fungicides, insecticides, acaricides or nutrient solutions by introducing the treatment composition into the soil or onto the foliage requires the use of large amounts of the treatment compositions in question, only fractions of these becoming active over relatively short periods before the treatment compositions are washed off or leached out by precipitation.

It has therefore already been suggested to inject the treatment compositions into the vascular elements of the sapwood, which translocate water and nutrient salts, so that these compositions, together with the nutrient salt solution, are translocated within the whole plant as far as the leaves.

WO98/42181 describes a cannula with a pyramidal tip and lateral bore closely behind the tip.

BE 859 547 describes an injection drill equipped with a plurality of lateral bores, which are distributed along the entire length of the drill and the entire circumference of the drill.

U.S. Pat. No. 4,103,456 describes a cannula equipped with a plurality of lateral bores distributed along the circumference of the cannula, a thread and a two-way cock.

The known devices have a variety of disadvantages; thus, the application times are long, the application rates required high, and the damage inflicted on the treated woody species significant. Moreover, the known devices are difficult to make in some cases and/or suffer from low stability. The methods of treating woody plants using the above devices are complicated and/or laborious in some cases.

The problem to be solved is therefore to provide devices for injecting plant treatment compositions which do not suffer from one or more of the above disadvantages.

This problem is solved by the devices for injecting plant treatment compositions, which devices are described hereinbelow.

The invention proposes a device comprising a cylindrical injection element equipped with an axial bore, a radial slot which communicates with the above bore and whose longitudinal axis is essentially parallel to the axial bore; a fixing element and an element for connecting a reservoir.

The end of the device which is equipped with the element for connecting a reservoir is referred to as the rear end, or rear; accordingly, the opposite end of the device is the front end, or front. The entire device is also referred to as cannula.

The front end of the cylindrical injection element can have a variety of shapes, for example as the result of the production process. Possibilities are designed in the form of a tip, a spherical curvature or a plane end. The design of a plane end is preferred.

The axial bore runs either through all or only part of the cannula (“pot bore”). A cannula provided with an axial pot bore is preferred. If a pot bore is present, the remaining thickness of material corresponds, for example, to the diameter of the cylindrical injection element. In an alternative embodiment the remaining thickness of material corresponds to the wall thickness of the cylindrical injection element. The remaining thickness of material amounts for example to 0.2-10 mm, preferably 3-6 mm, especially preferably 5 mm.

The slot is characterized by its length, width, shape and the shape of the lateral faces. The length of the radial slot can be varied within a wide range. The slot at its maximum reaches from the tip of the cannula to the fixing element. Preferably, the slot starts at a distance x from the tip, the distance x corresponding to the diameter of the cannula. The length of the slot is for example 5-20 mm, preferably 8-15 mm, especially preferably 10 mm. The width of the slot can be varied within a wide range. For example, the width of the slot is 1/10 to 10/10, preferably 2/10 to 8/10, especially preferably 4/10 to 6/10, of the diameter of the cannula. The width of the slot is, for example, 0.5-6 mm; preferably, it is for example 2-5 mm. The slot can be designed as an elongated hole or a square. The longitudinal axis runs essentially parallel with the longitudinal axis of the cannula. In an alternative embodiment, the slot can be replaced by a plurality of bores whose arrangement corresponds to the above-described shape and orientation of the slot. The lateral faces of the slot can be arranged parallel with one another or radially or take on an angle between these extremes.

The fixing element can be designed in the form of one or more washers or wraparound rings and/or in the form of a thread. Materials which are suitable for the washers or wraparound rings are all elastic materials such as, for example, natural or synthetic rubber or polydienes. The thread shapes can be varied within a wide range. It is possible to use both conical threads and parallel threads. Threads are preferred as fixing elements. Especially preferred are parallel threads (machine thread). The fixing element simultaneously acts as element for sealing the bore in the woody plant against the environment.

The element for connecting a reservoir is known to the skilled worker. Possible embodiments are external or internal threads, bayonet joints or other quick-fit joints.

In addition, the cannula can be provided with an adjusting element. Suitable adjusting elements are external driving flats for example square or hexagonal; internal driving flats for example recession, cross-recession, internal hexagon, screws or toggles.

In addition, the cannula may be provided with a sealing element. The sealing element may be designed as a two-way cock or a three-way cock. It is preferred to use a three-way cock. The sealing element can be permanently or detachably connected to the cannula. If the sealing element is permanently connected to the cannula, it can be arranged within the projection of the slot and thus simultaneously act as the marker.

In addition, the cannula may be provided with a marker element, which indicates the position of the slot. This element can be for example a color marker or a groove. The adjusting element or the sealing element may also act as marker element as the result of its design and/or positioning.

Suitable materials for the cannula are metal or polymers. Examples of metal materials are alloys based on iron, copper or aluminum. Preferred metallic materials are brass alloys and stainless-steel alloys. Examples of polymers are polyolefins, polyesters, polyamides, polycarbonates and blends of these polymers.

The invention is subsequently illustrated in greater detail with the aid of the appended figures, which only show one embodiment:

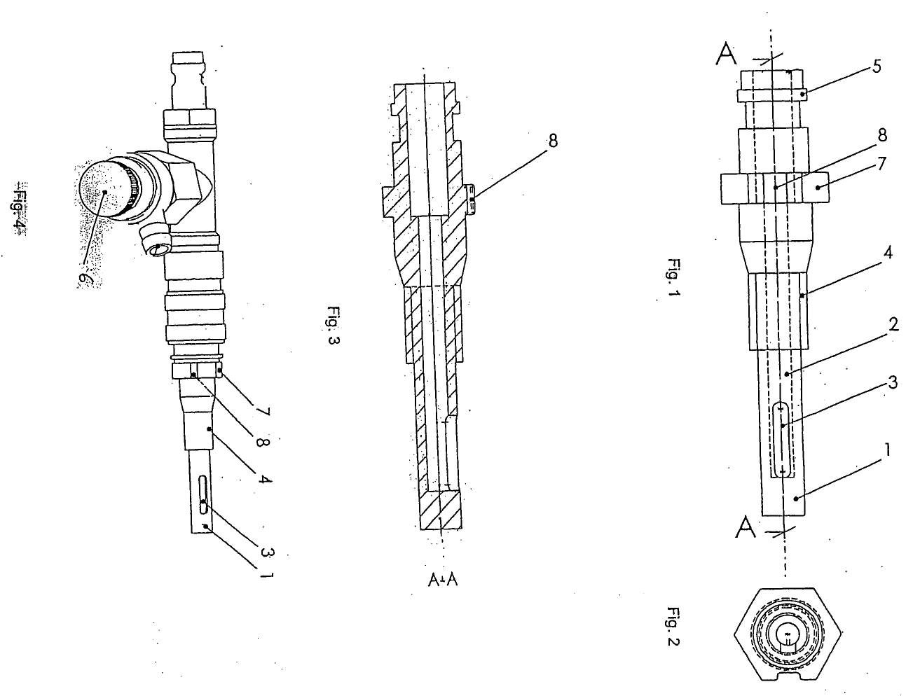

FIG. 1 shows a side view of a cannula according to the invention

FIG. 2 shows a top view of a cannula according to the invention

FIG. 3 shows a side view of a cannula according to the invention along the step A-A

FIG. 4 shows an alternative embodiment of a cannula according to the invention in three-dimensional representation.

The following reference signs are used in the figures:
(1) cylindrical injection element
(2) axial bore
(3) slot
(4) fixing element
(5) element for connecting a reservoir
(6) sealing element
(7) adjusting element
(8) marker element

The present invention furthermore relates to an apparatus for treating woody plants, comprising i) a cannula as described above connected via a line to ii) a device for storing plant treatment compositions which, in turn, communicates via a line with iii) a device for generating the pressure. In a preferred embodiment of the apparatus, the cannula communicates via a flexible, pressure-resistant line with the storage device. In a further preferred embodiment of the apparatus, the device for storing plant treatment compositions and the device for generating the pressure are mounted within a shared housing. In a further preferred embodiment of the apparatus, a plurality of cannulas communicate with to the device for storing plant treatment compositions via a flexible line which is designed as a ring or star. The above embodiments of the apparatus may, if appropriate, be combined with one another.

The present invention furthermore relates to a method of treating woody plants, characterized in that, in a first step, a small area of bark is removed, in a second step, an essentially horizontal hole is bored into the stem of a woody plant; in a third step, the above-described cannula is introduced into this borehole, fixed and adjusted in such a way that the radial slot (3) points vertically upwards; in a fourth step, the plant treatment composition is delivered via the connection element (5) in such a way that an essentially bubble-free delivery of the plant treatment composition is ensured; in a fifth step, the pressurized plant treatment composition is allowed to be taken up by the woody plant over the period required, and, in a sixth step, the above-described cannula is detached and, if appropriate, the borehole which remains is sealed by methods with which the skilled worker is familiar.

The borehole which is produced in the second step has at least the diameter of the cylindrical injection element and exceeds the diameter of the latter by not more than 1/10. Preferably, the diameter of the borehole and of the cylindrical injection element are identical. The depth of the borehole depends on the thickness of the water-translocating sapwood. On the one hand, the borehole should be as shallow as possible; on the other hand, however, as deep as the cannula is long. In general, a depth of 1-10 cm will suffice. The orientation of the borehole is essentially horizontal and essentially axial. The borehole can be made using customary drills. One possibility is to the use of twist drills for wood. An alternative possibility is the use of wood augers.

The pressure under which the plant treatment composition acts in the fourth step, can be varied within a broad range. Preferred is a pressure range which is above ambient pressure, but does not inflict undue damage to the woody plant and ensures safe anchorage of the cannula. Examples which may be mentioned are pressures of 1-30 bar, preferably 1-10 bar, especially preferably 1.5-8 bar.

Suitable plant treatment compositions are all the substances which have an effect on woody plants. These are, in particular, substances with fungicidal, insecticidal, acaricidal, nematicidal and herbicidal activity, and also fertilizers and nutrients. These substances are known to the skilled worker and are described for example in “The Pesticide Manual, 10^{th} edition, British Crop Protection Council”. Especially suitable are insecticides from the class of the nicotinyls, the nebnicotinyls, the pyrethroids, the organophosphates, the ketoenols and fosetyl-aluminum. The plant treatment compositions are used in liquid formulation. Suitable formulations are solutions, emulsions, suspensions.

Suitable woody plants are trees dignified, upright, perennial plants which, if left to grow undisturbed, reach a height of at least 6 m and which have a lower trunk section without branches) and shrubs dignified perennial plants which branch out at a short distance from the ground). Preferred woody plants are deciduous trees. Those which may be mentioned in particular are diffuse-porous and ring-porous deciduous species. Especially preferred are diffuse-porous deciduous species. Likewise especially preferred are trees of the genus Pinus. Very especially preferred are horse-chestnut (Aesculus spec.), plane-tree (Platanus spec.), lime (Tilia spec.), maple (Acer spec.) and eucalyptus (Myrtaceae spec.), as well as palm. Woody plants whose stem diameter exceeds 10 cm are preferred. Woody plants whose stem diameter exceeds 20 cm are especially preferred.

The bubble-free delivery of the plant treatment composition is known to the skilled worker. This can be achieved for example by removing any air which is present in the system. As an alternative, the use of a three-way cock makes it possible first to deliver plant treatment composition until all of the system is bubble-free and only then delivering plant treatment composition into the stem by turning the cock.

In an alternative method, a plurality of injections can be carried out simultaneously on one and the same woody plant along the circumference of the stem, if appropriate at different levels.

The present invention is illustrated by the examples which follow.

1. A device for treating woody plants, comprising a cylindrical injection element (1) equipped with an axial bore (2); a radial slot (3) which communicates with the above bore (2) and whose longitudinal axis is essentially parallel to the axial bore (2); a fixing element (4) and an element for connecting a reservoir (5).

2. The device as claimed in claim 1, characterized in that the axial bore (2) is embodied in the form of a pot bore.

3. The device as claimed in claim 1 or 2, characterized in that a sealing element (6) is arranged between the fixing element (4) and the element for connecting a reservoir (5).

4. The device as claimed in claim 3, characterized in that the sealing element (6) is a three-way cock.

5. The device as claimed in claim 1, characterized in that the fixing element (4) is a thread.

6. The device as claimed in claim 1, characterized in that an element for turning and/or adjusting (7) the device is arranged behind the fixing element (4).

7. The device as claimed in claim 1, characterized in that a marker element (8), which indicates the position of the radial slot (3) is provided behind the fixing element (4).

8. A method of treating woody plants, characterized in that
in a first step, a small area of bark is removed,
in a second step, an essentially horizontal hole is bored into the stem of a woody plant;
in a third step, the device as claimed in claim 1 is introduced into this borehole, fixed and adjusted in such a way that the radial slot (3) points vertically upwards;
in a fourth step, the plant treatment composition is delivered via the connection element (5) in such a way that an essentially bubble-free delivery of the plant treatment composition is ensured;
in a fifth step, the pressurized plant treatment composition is allowed to be taken up by the woody plant over the period required, and,
in a sixth step, the above-described cannula is detached and, if appropriate, the borehole which remains is sealed by methods with which the skilled worker is familiar.

9. The method as claimed in claim 8, characterized in that a plurality of injections are carried out simultaneously on one and the same woody plant along the circumference of the stem.

10. An apparatus for treating woody species, comprising one or more devices as claimed in claim 1 connected to a device for storing plant treatment compositions and a device for generating pressure.
